(19) United States
(12) Patent Application Publication
(10) Pub. No.: US 2015/0206205 A1
(43) Pub. Date: Jul. 23, 2015

(54) SELECTIVELY ANONYMOUS NETWORK-ENABLED RATING/EVALUATING SYSTEM

(71) Applicants: John WILLCOX, Berwyn, PA (US); John WILLCOX, JR., (US)

(72) Inventors: John Willcox, Berwyn, PA (US); John Willcox, JR., Berwyn, PA (US)

(21) Appl. No.: 14/421,591

(22) PCT Filed: Aug. 14, 2013
(86) PCT No.: PCT/US2013/054958

§ 371 Date: Feb. 13, 2015

Related U.S. Application Data
(60) Provisional application No. 61/682,922, filed on Aug. 14, 2012.

(51) Int. Cl. G06Q 30/02; G06Q 50/18

(52) U.S. Cl. CPC G06Q 30/0282; G06Q 50/18

(57) ABSTRACT

This invention relates to a system for eliciting, compiling, organizing, and giving access to information, and in particular, evaluation information, regarding providers of professional services. The specific example described herein is directed to a web based rating service and system dedicated to the litigation business world. It provides clients with a comprehensive review of all parties involved in litigation through a rating system specifically designed to fairly evaluate the performances of Judges, Mediators, Experts and Arbitrators. This service and system connects thousands of professionals in the legal industry and allows them to share reviews, comments and knowledge. Users who are part of the same organization (e.g., co-workers) can see the identity of each other to facilitate in-person discussions of the person being evaluated, while the identity of users who are not members of the same organization always remain anonymous.

### CROSS-REFERENCE TO RELATED APPLICATIONS

This application is based on and claims priority to U.S. Provisional Application No. 61/682,922, filed on Aug. 14, 2012, the entire contents of which is fully incorporated herein by reference.

### BACKGROUND OF THE INVENTION

1. Field of the Invention

This invention relates to a system for eliciting, compiling, organizing, and giving access to information, and in particular, evaluation information, regarding providers of professional services.

2. Description of the Related Art

Network accessible rating and evaluation systems are known in the art. Ratemyprofessor.com is one example of such a system, whereby persons can sign onto a network (e.g., via a website) and provide rating information, anonymously, about professors and teachers with whom the user has experience. Many such systems are open, that is, anyone can sign on and use the system and provide ratings, whether or not such ratings are based on true experience. Further, such systems are entirely anonymous, which prohibits any meaningful follow-up discussions between the people providing the ratings, and which prevents any form of judgments to be made regarding the veracity of the information contained in the ratings.

U.S. Patent Application Publication No. 2006/0190490, published Aug. 24, 2006; U.S. Patent Application Publication No. 2008/0195480, published Aug. 14, 2008; U.S. Patent Application Publication No. 2010/0017431, published Jan. 21, 2010; and U.S. Patent Application Publication No. 2011/0060737, published Mar. 10, 2011, all of which are incorporated fully herein by reference, disclose various systems evaluation systems, none of which enable the identity of a user who has prepared and submitted an evaluation to be provided to other users who are associated with a common organization (i.e., the same company, same professional organization, same law firm, etc.).

### SUMMARY OF THE INVENTION

This invention relates to a system for eliciting, compiling, organizing, and giving access to information, and in particular, evaluation information, regarding providers of professional services. The specific example described herein is directed to a web based rating service and system dedicated to the litigation business world. It provides clients with a comprehensive review of all parties involved in litigation through a rating system specifically designed to fairly evaluate the performances of Judges, Mediators, Experts and Arbitrators. This service and system connects thousands of professionals in the legal industry and allows them to share reviews, comments and knowledge. Users who are part of the same organization (e.g., co-workers) can see the identity of each other to facilitate in-person discussions of the person being evaluated, while the identity of users who are not members of the same organization always remain anonymous.

### BRIEF DESCRIPTION OF THE DRAWINGS

FIG. 1 illustrates the basic process steps followed in providing the services described herein, in accordance with the invention;

FIG. 2 illustrates the various procedures carried out by administrators, managers, and employees using the system of the invention; and

FIGS. 3 and 4 illustrate a typical processing which can be used to create and manage the hierarchical structures in accordance with the present invention.

### DETAILED DESCRIPTION OF THE PREFERRED EMBODIMENTS

What follows is a description of the invention as it relates to a legal marketplace. It is understood that this is given for purposes of example and the invention is not so limited. It is understood that they system of the invention can be utilized in any environment and/or situation in which confidential evaluations are solicited and in which the evaluations are shared with others, confidentially except as between members of the same organization.

In a preferred embodiment the invention includes a social media type of website that is individually tailored to each company (ie. Insurance company A or lawfirm B). Within the individual setup, managers can post articles, leave notes, suggest their top 5 picks for each state in each category and top 5 “do not use” etc. Virtually any basis for rating, evaluating, ranking and the like can be used, and it is understood that the invention, while described in connection with evaluating judges, mediators, experts, and arbitrators, is not limited to those categories of service providers and in fact can be utilized in connection with providers of services of any kind.

Significant to the invention is that the system is configured to enable employees of the same company to be able to view comments made by coworkers and contact them to discuss their comments and ratings. The rating system will be much like Ratemyprofessor.com and other websites. User ratings and comments will be based upon the universal user, meaning that everyone will be able to see all ratings and comments but they will show up as anonymous unless made by someone within your own company. A blog section will also be incorporating for trending hot topics along with events/articles/news. However, unlike known systems, which do not allow selective sharing of information about the identity of the evaluators but instead rely on that information being kept secret vis-a-vis the other evaluators, the system of the invention is configured so that when a segment of the evaluators are part of the same organization (e.g., the same company, same law firm, etc) and information within the organization is shared freely among the members of that organization, the identities of the evaluators who are members of that organization are shared among each other. This facilitates additional communications between the various members so that they may follow up and ask more questions about the evaluated individuals, and so that judgments can be made about the veracity of the evaluations.

Users will also be able to leave additional comments. Administrators will create new entities as and when required.

It is contemplated that access to the system of the invention will be made via accessing a portal on a network, although access to the system is not limited to this method. The portal will include major sections and a place holder for text based resources. For example, there will be sections for:

1) an overview to the system (information that any and all can view to decide if they want to become a member of the system;

2) an introduction and overview/tour (what people will first see when they enter the system portal), which can include:
User Registration Module
Search Options
Listing of Registered Members
News and Article Section (posted by members)
Events Section
Posting Review Section
Review of the Week
Top Rated (about 5) section
User Profile Management
Users Personal Page
Reporting Dashboard
Customer Support
Contact us page
Advertise with us page
There will be backend support for the product. The site will be easily updateable and maintainable and will be Search Engine Optimization (SEO) friendly.
There will be reporting and metrics reporting modules e.g.
Number of visitors, number of repeat visitors
Top visited pages
Time spent on site
What is being watched, downloaded
What is being reviewed
Where are visitors coming from
Where are visitors exiting from and where are they going
The portal will also have support for various functionalities e.g.
   Blogs
   Twitter feed
   Forums
   Social Network sharing (Face book, Diggit, You Tube, Twitter, etc.)
   Face book Connect (If required)
   Video

3) There will be provision for secure sign in—it is expected that Users will be able to create an account and get registered to the service's website. Users will also have forgotten password option to recover the forgotten password.

4) There will be a provision to display a list of companies who have membership with the service

In an example directed to litigation, the system will provide:
Nation based rating system for all areas of litigation
Provide clients with access to information pertinent to every file
Maintain a fair and balanced approach where all parties will have access to data base
Provide a venue for comments in reference to each party in litigation, comments are anonymous unless made by an employee of same company
Rating each party on a scale (e.g., 1-5) in numerous categories
Provide a secure network for each client, while still having availability to all comments and scores
Provide a one stop approach
Build a customer community that reflects the values necessary for a successful litigation result
Search Page: dedicated only to searching someone in any of the categories that have been set up. For example, the system will be able to search by (but is not limited to)
   Name—first or last
   State/jurisdiction
   Location
   Company they work for
   And, many other factors to be determined

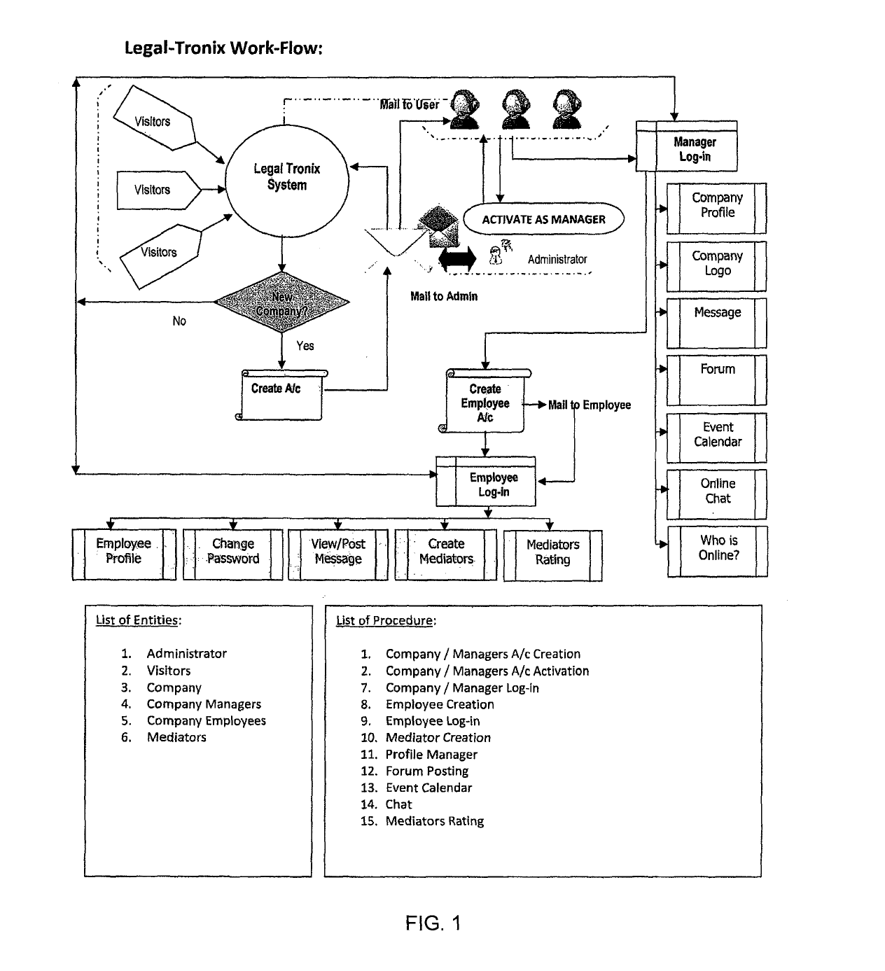

FIG. 1 illustrates the basic process steps followed in connection with a hypothetical company named Legal-Tronix that is providing the services described herein, in accordance with the invention. Visitors access the Legal-Tronix system, e.g., via a web or other network-based connection (hardwired or wireless) and it is determined if the visitor is a new visitor (e.g., a new company or an employee of a new company not currently having an account with Legal-Tronix).

If it is determined that the visitor is a new company, the process proceeds to access the steps needed to open a new account. Financial information is exchanged (including payment of a fee for the Legal-Tronix service if appropriate) and an administrator is set up (i.e., a person or persons from the new company are established as the administrators of the account so that they can set up and manage use by the new company and its employees). Various information is gathered regarding the company (profile information, logos, etc) and an account, with an “Employee Log-in” for each employee authorized to use the system, is set up.

If it is determined that the visitor has already established an account with Legal-Tronix, the process proceeds directly to the “Employee Log-in” step.

Once logged in, the employee accessing the system is able to change their employee information, change their password, create and view messages, identify persons to be evaluated and rated (in this example, mediators), and give the ratings and other evaluative information.

Although not expressly shown in FIG. 1, the accounts are set up so that whenever an employee logs in to the system, they can see all evaluations made by any users of the system, and if an evaluations was made by a member of the same company, they are also given access to the identity of their fellow employee who provided the evaluation.

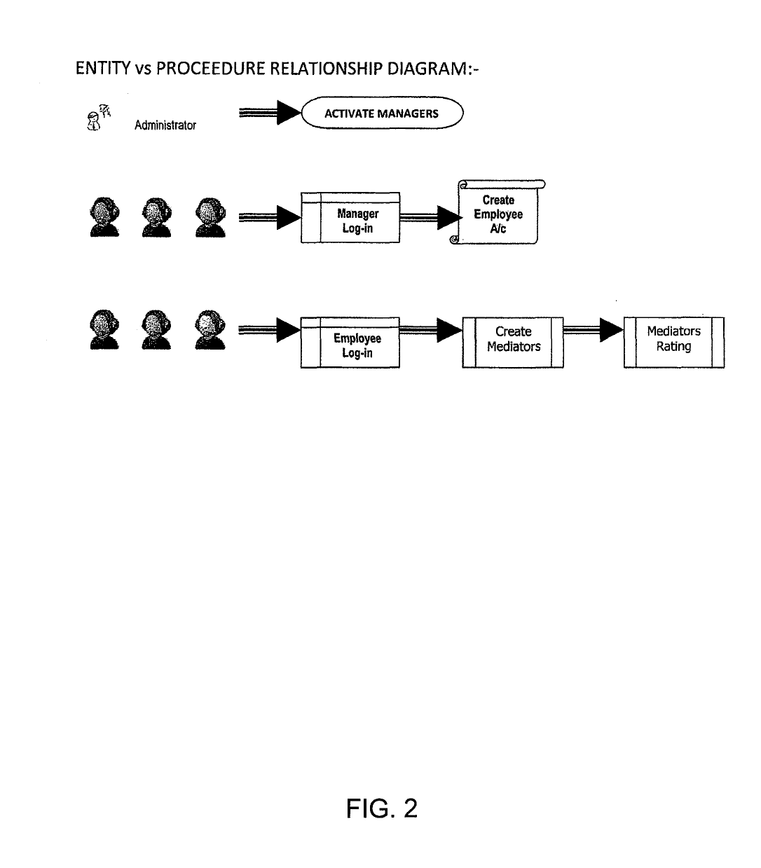

FIG. 2 illustrates the various procedures carried out by administrators, managers, and employees using the system of the invention.

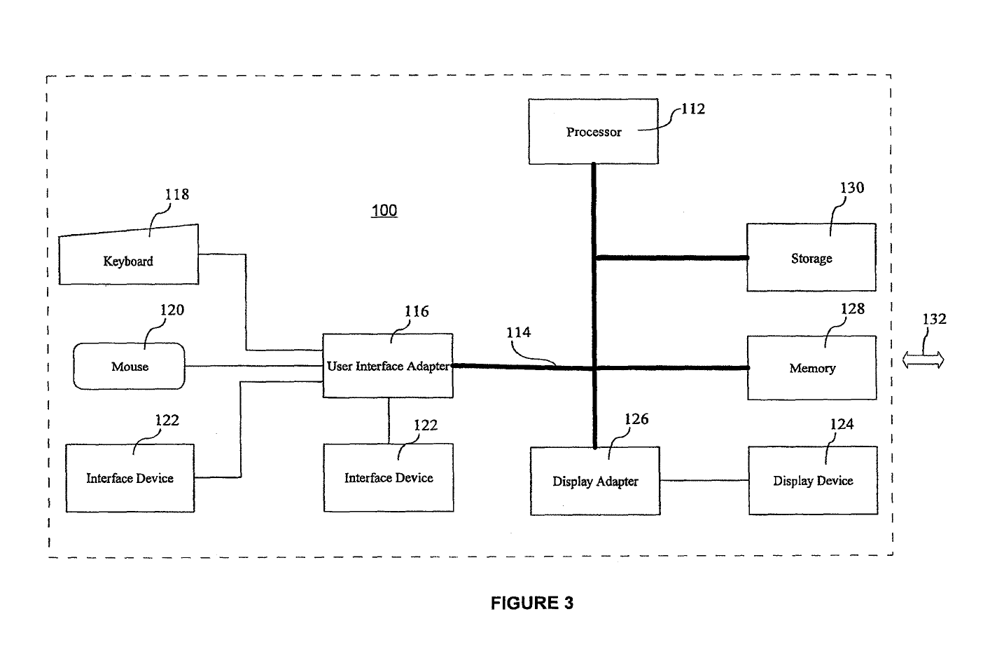

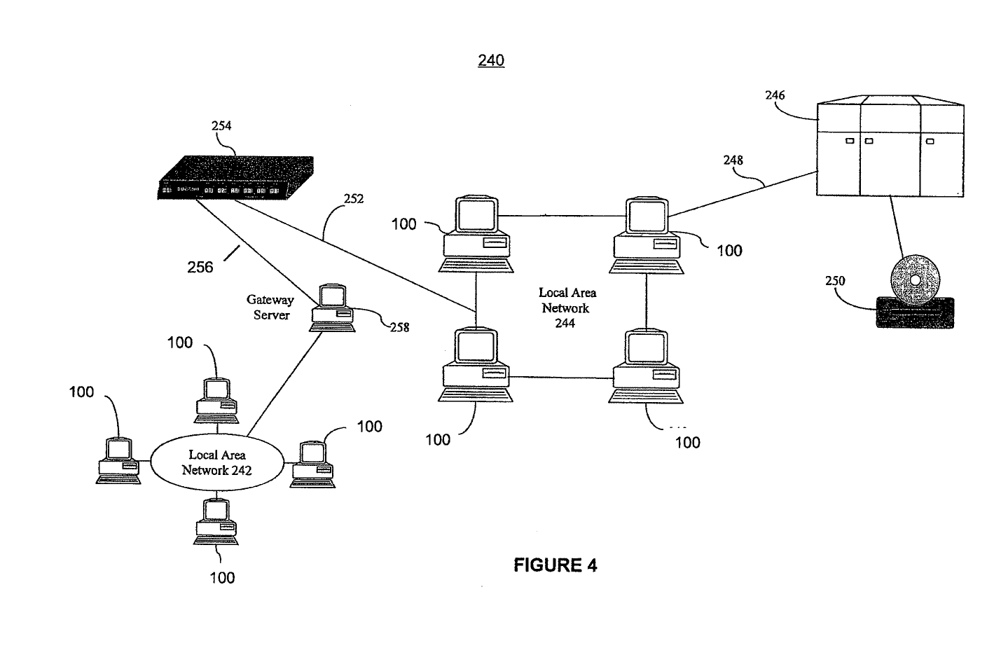

FIGS. 3 and 4 illustrate a typical processing which can be used to create and manage the hierarchical structures in accordance with the present invention. FIG. 3 illustrates a representative workstation hardware environment in which the present invention may be practiced. The environment of FIG. 3 comprises a representative single user computer workstation 100, such as a personal computer, including related peripheral devices. The workstation 100 includes a microprocessor 112 and a bus 114 employed to connect and enable communication between the microprocessor 112 and the components of the workstation 100 in accordance with known techniques. The workstation 100 typically includes a user interface adapter 116, which connects the microprocessor 112 via the bus 114 to one or more interface devices, such as keyboard 118, mouse 120, and/or other interface devices 122, which can be any user interface device, such as a touch sensitive screen, digitized entry pad, etc. The bus 114 also connects a display device 124, such as an LCD screen or monitor, to the microprocessor 112 via a display adapter 126. The bus 114 also connects the microprocessor 112 to memory 128 and long term storage 130 which can include a hard drive, tape drive, etc.

The workstation 100 communicates via a communications channel 132 with other computers or networks of computers. The workstation 100 may be associated with such other computers in a local area network (LAN) or a wide area network, or the workstation 100 can be client in a client/server arrangement with another computer, etc. All of these configurations, as well as the appropriate communications hardware and software, are known in the art.

FIG. 4 illustrates a data processing network 240 in which the present invention may be practiced. The data processing network 240 includes a plurality of individual networks, including LANs 242 and 244, each of which includes a plurality of individual workstations 100. Alternatively, as those skilled in the art will appreciate, a LAN may comprise a plurality of intelligent workstations coupled to a host processor.

Still referring to FIG. 4, the data processing network 240 may also include multiple mainframe computers, such as a mainframe computer 246, which may be preferably coupled to the LAN 244 by means of a communications link 248.

The mainframe computer 246 may also be coupled to a storage device 250, which may serve as remote storage for the LAN 244. Similarly, the LAN 244 may be coupled to a communications link 252 through a router 254 and a communications link 256 to a gateway server 258. The gateway server 258 is preferably an individual computer or intelligent workstation which serves to link the LAN 242 to the LAN 244.

Those skilled in the art will appreciate that the mainframe computer 246 may be located a great geographic distance from the LAN 244, and similarly, the LAN 244 may be located a substantial distance from the LAN 242. For example, the LAN 242 may be located in California, while the LAN 244 may be located in Texas, and the mainframe computer 246 may be located in New York.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Although the present invention has been described with respect to a specific preferred embodiment thereof, various changes and modifications may be suggested to one skilled in the art and it is intended that the present invention encompass such changes and modifications as fall within the scope of the invention, as set forth in the appended claims, if any.

We claim:

1. An evaluation system for evaluating products or service-providers, comprising:
a database containing evaluation data regarding a plurality of products and/or service-providers, said evaluation data being prepared by users of said evaluation system;
a server configured to receive queries regarding products and/or services, and to output said evaluation data to users of said evaluation system based on said queries;
wherein:
identity information regarding a first user who has prepared evaluation information regarding a first product or service-provider is, by default, withheld from other users of said evaluation system; and
identity information regarding the first user is provided to users of said evaluation system who are associated with a common organization.

2. The evaluation system of claim 1, wherein said service providers comprise legal professionals.

3. The evaluation system of claim 2, wherein said legal professionals comprise judges.

4. The evaluation system of claim 2, wherein said legal professionals comprise lawyers.

5. The evaluation system of claim 2, wherein said legal professionals comprise mediators.

6. The evaluation system of claim 2, wherein said legal professionals comprise arbitrators.

7. The evaluation system of claim 2, wherein said legal professionals comprise expert witnesses.

8. The evaluation system of claim 2, wherein said legal professionals comprise any of lawyers, judges, arbitrators, and mediators.

9. The evaluation system of claim 1, wherein said organization comprises a law firm.

10. The evaluation system of claim 1, wherein said organization comprises a company.

11. The evaluation system of claim 1, wherein said organization comprises an insurance company.
